(19) United States
(12) Patent Application Publication
(10) Pub. No.: US 2025/0115313 A1
(43) Pub. Date: Apr. 10, 2025

(54) MODULAR UTILITY VEHICLE

(71) Applicant: AgHand Technologies, L.L.C., Valley, NE (US)

(72) Inventors: Preston Parmley, Valley, NE (US); Ben Carson, Elkhorn, NE (US); John Wagner, Petersburg, NE (US)

(21) Appl. No.: 18/908,518

(22) Filed: Oct. 7, 2024

Related U.S. Application Data
(60) Provisional application No. 63/543,000, filed on Oct. 6, 2023.

(51) Int. Cl. B62D 55/084; B60K 1/02; B60L 15/20; B62D 63/02

(52) U.S. Cl. CPC B62D 55/084; B60K 1/02; B60L 15/20; B62D 63/025; B60L 2200/40

(57) ABSTRACT

A modular continuous track system for a utility vehicle is disclosed. The modular continuous track system may include a first crawler unit comprising a first electric motor and a first track mounting system configured to couple the first crawler unit to a first utility platform. The modular continuous track system may include a second crawler unit comprising a second electric motor and a second track mounting system configured to couple the second crawler unit to the first utility platform. The modular continuous track system may include a control system configured to control operation of the first crawler unit and the second crawler unit comprising: a first motor controller electrically coupled to a main controller and the first electric motor, a second motor controller electrically coupled to the main controller and the second electric motor; and the main controller.

### CROSS-REFERENCE TO RELATED APPLICATION

The present application claims the benefit under 35 U.S.C. § 219 (e) of U.S. Provisional Application Ser. No. 63/543,000 filed Oct. 6, 2023, naming Preston Parmley, Ben Carson, and John Wagner as inventors, which is incorporated herein by reference in the entirety.

### TECHNICAL FIELD

The present disclosure relates to a continuous track system, particularly modular continuous track systems for utility vehicles.

### BACKGROUND

Vehicles utilizing continuous track or tracked treads, such as utility vehicles and skid steers, are used in a variety of environments. Often, the design of these vehicles include a single attachment or platform (e.g., such as a bucket loader), with the continuous track system built to fit the attachment or platform. Because these vehicles are designed for a single platform or attachment, changing a design of the platform or attachment may require redesigning the continuous track system. Further, these designs offer little flexibility for changing attachments. Therefore, it is desirable to provide a system and method for overcoming the shortfalls of the previous approaches discussed above.

### SUMMARY

A modular continuous track system is disclosed, in accordance with one or more illustrative embodiments. In one illustrative embodiment, the modular continuous track system includes a first crawler unit including a first electric motor and a first track mounting system configured to couple the first crawler unit to a first utility platform. In another illustrative embodiment, the modular continuous track system includes a second crawler unit including a second electric motor and a second track mounting system configured to couple the second crawler unit to the first utility platform. In another illustrative embodiment, the modular continuous track system includes a control system configured to control the operation of the first crawler unit and the second crawler unit. The control system includes a first motor controller electrically coupled to a main controller and the first electric motor, a second motor controller electrically coupled to the main controller and the second electric motor, and the main controller.

A utility vehicle is disclosed, in accordance with one or more embodiments of the disclosure. In one illustrative embodiment, the utility vehicle includes a utility platform. In another illustrative embodiment, the utility vehicle includes a modular continuous track system coupled to the utility platform. In another illustrative embodiment, the modular continuous track system includes a first crawler unit including a first electric motor and a first track mounting system configured to couple the first crawler unit to a first utility platform. In another illustrative embodiment, the modular continuous track system includes a second crawler unit including a second electric motor and a second track mounting system configured to couple the second crawler unit to the first utility platform. In another illustrative embodiment, the modular continuous track system includes a control system configured to control the operation of the first crawler unit and the second crawler unit. The control system includes a first motor controller electrically coupled to a main controller and the first electric motor, a second motor controller electrically coupled to the main controller and the second electric motor, and the main controller.

A method for exchanging a first utility platform with a second utility platform on a modular continuous track system is disclosed, in accordance with one or more embodiments of the disclosure. In one illustrative embodiment, the method includes decoupling a first track mounting system of a first crawler unit from the first utility platform. In another illustrative embodiment, the method includes decoupling a second track mounting system of a second crawler unit from the first utility platform. In another illustrative embodiment, the method includes removing an electronic enclosure from the first utility platform, wherein the electronic enclosure includes a main controller, a first motor controller, and a second motor controller. In another illustrative embodiment, the method includes coupling the track mounting system of the first crawler unit to the second utility platform. In another illustrative embodiment, the method includes coupling the second track mounting system to the second utility platform. In another illustrative embodiment, the method includes coupling the electronic enclosure to the second utility platform.

It is to be understood that both the foregoing general description and the following detailed description are exemplary and explanatory only and are not necessarily restrictive of the invention as claimed. The accompanying drawings, which are incorporated in and constitute a part of the specification, illustrative embodiments of the invention, and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1A illustrates a modular continuous track system for utility vehicles, in accordance with one or more embodiments of the disclosure.

FIG. 1B illustrates a closeup side-view of a crawler unit, in accordance with one or more embodiments of the disclosure.

FIG. 1C and FIG. 1D illustrate the modular continuous track system with the crawler units arranged in a narrow and wide configuration, respectively, in accordance with one or embodiments of the disclosure.

FIG. 1E illustrates a simplified schematic view of a control system for the system, in accordance with one or more embodiments of the disclosure.

FIG. 1F illustrates a side view of a utility vehicle that includes a mower platform, in accordance with one or more embodiments of the disclosure.

FIG. 1G illustrates a side view of a utility vehicle that includes a dump bucket platform, in accordance with one or more embodiments of the disclosure.

FIG. 1H illustrates a side view of a utility vehicle that includes a loader platform, in accordance with one or more embodiments of the disclosure.

FIG. 1I illustrated a side view of a utility vehicle that includes a hauling platform, in accordance with one or more embodiments of the disclosure.

FIG. 2A illustrates a side-view of a utility vehicle, in accordance with one or more embodiments of the disclosure.

FIG. 2B illustrates a perspective view of the utility vehicle, in accordance with one or more embodiments of the disclosure.

FIG. 2C illustrates a front view of the utility vehicle, in accordance with one or more embodiments of the disclosure.

FIG. 2D illustrates a top view of the utility vehicle, in accordance with one or more embodiments of the disclosure.

FIG. 3 illustrates a side view of the utility vehicle, in accordance with one or more embodiments of the disclosure.

FIG. 4 illustrates a conceptual view of the utility vehicle system, in accordance with one or more embodiments of the disclosure.

FIG. 5 illustrates a process flow diagram depicting a method for exchanging a first utility platform with a second utility platform on a modular continuous track system, in accordance with one or more embodiments of the disclosure.

### DETAILED DESCRIPTION

Reference will now be made in detail to the subject matter disclosed, which is illustrated in the accompanying drawings.

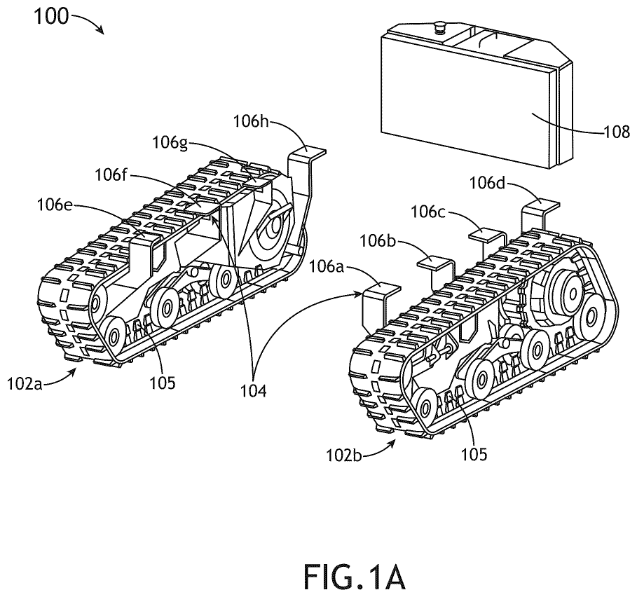

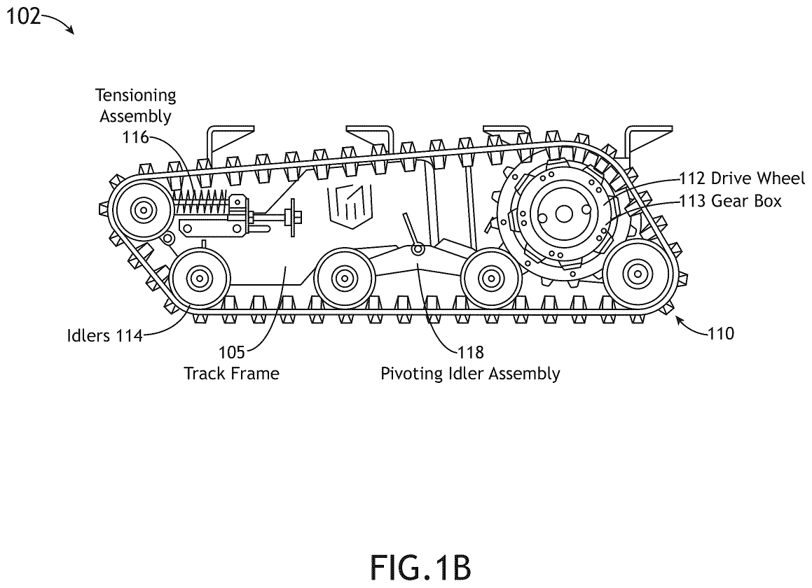

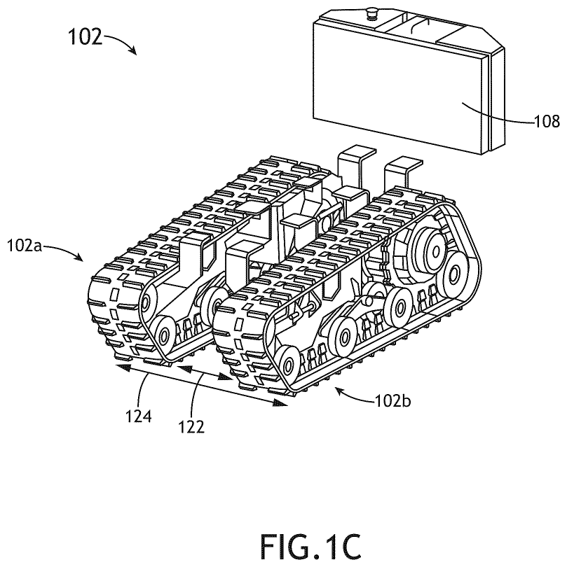

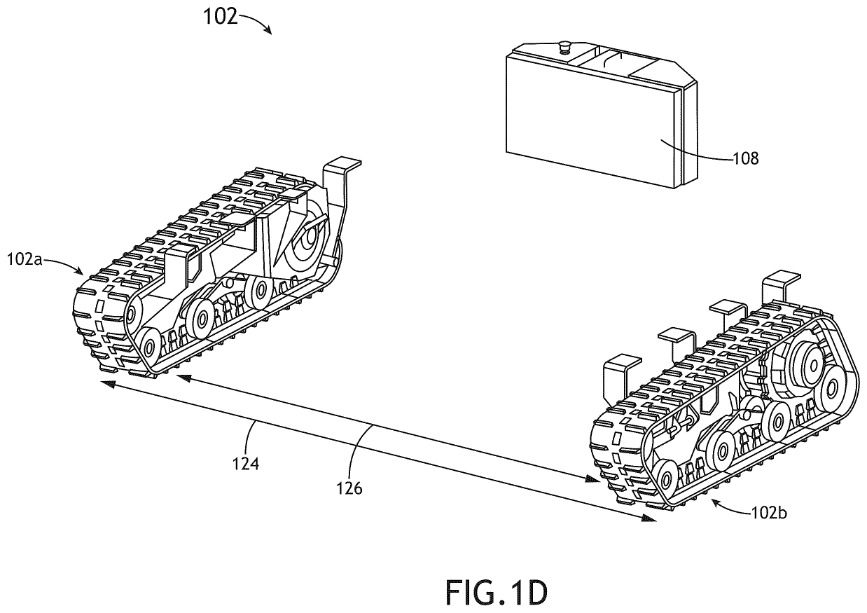

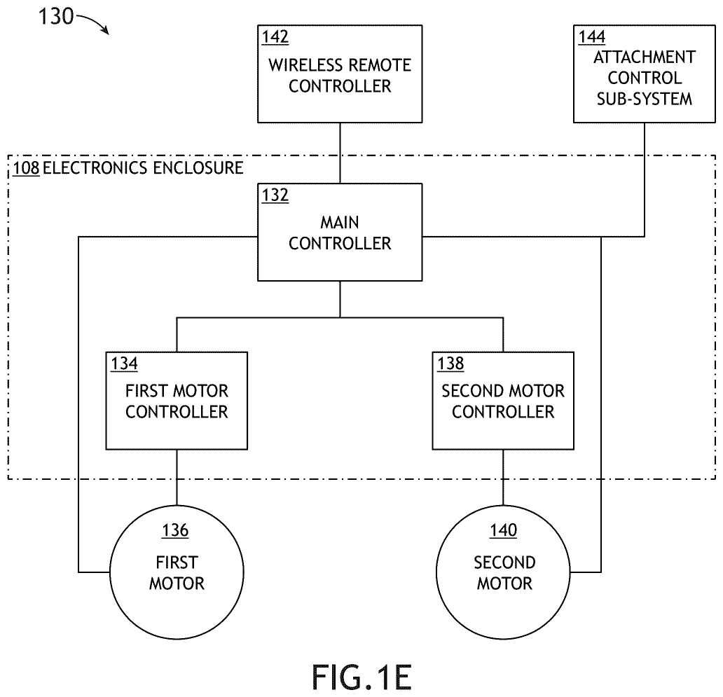

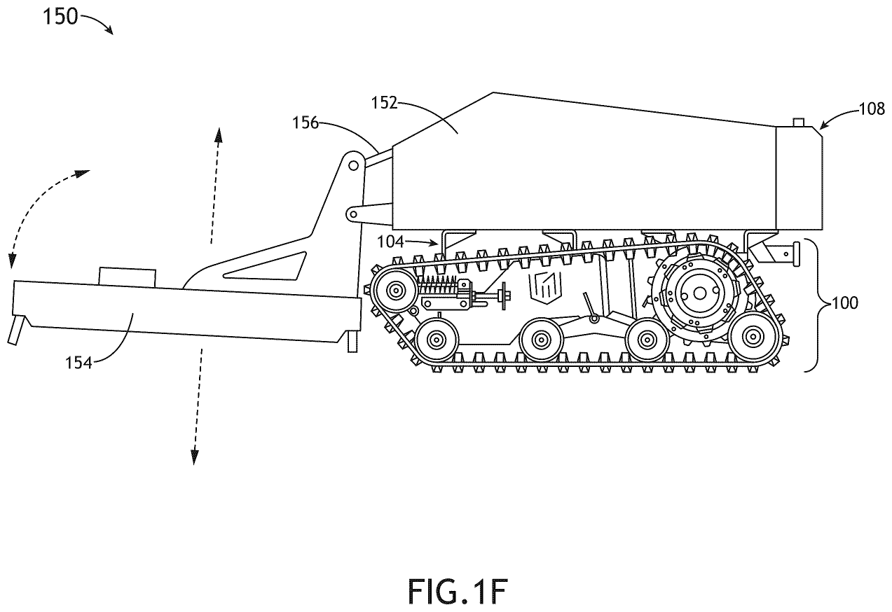

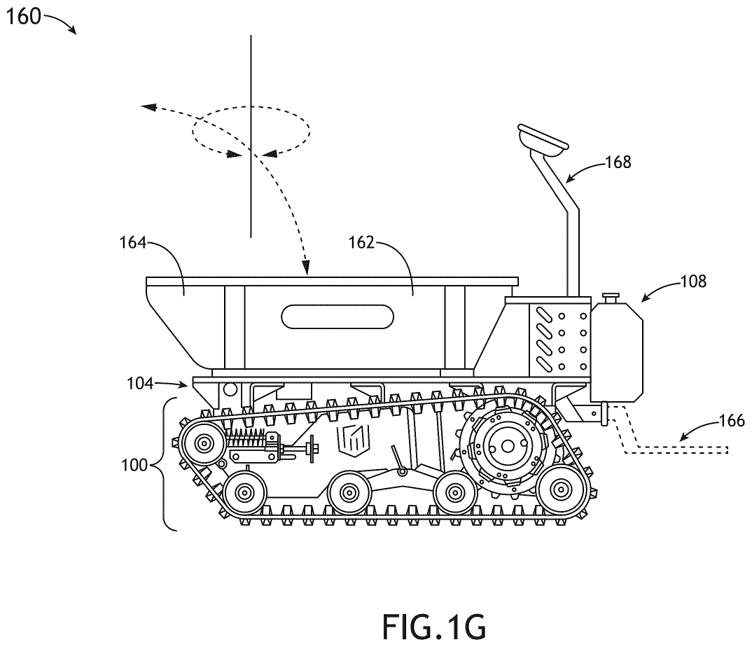

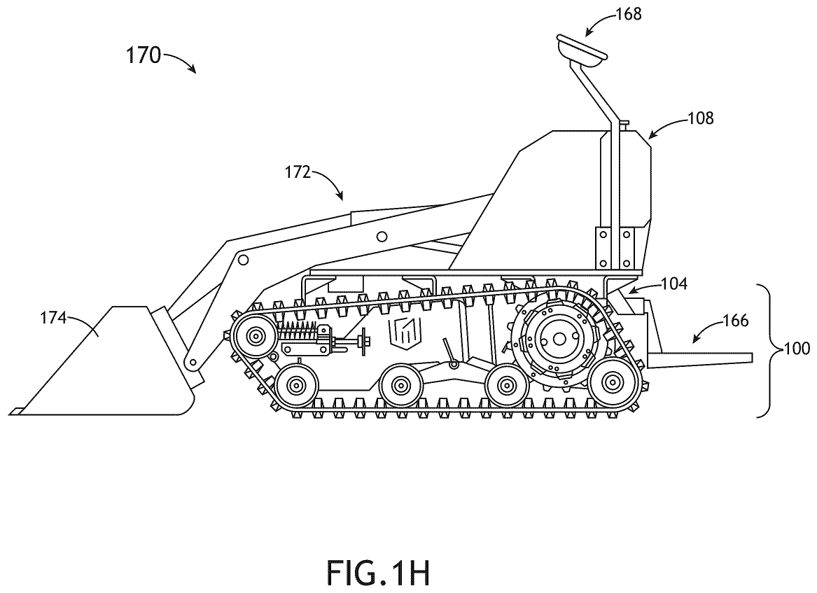

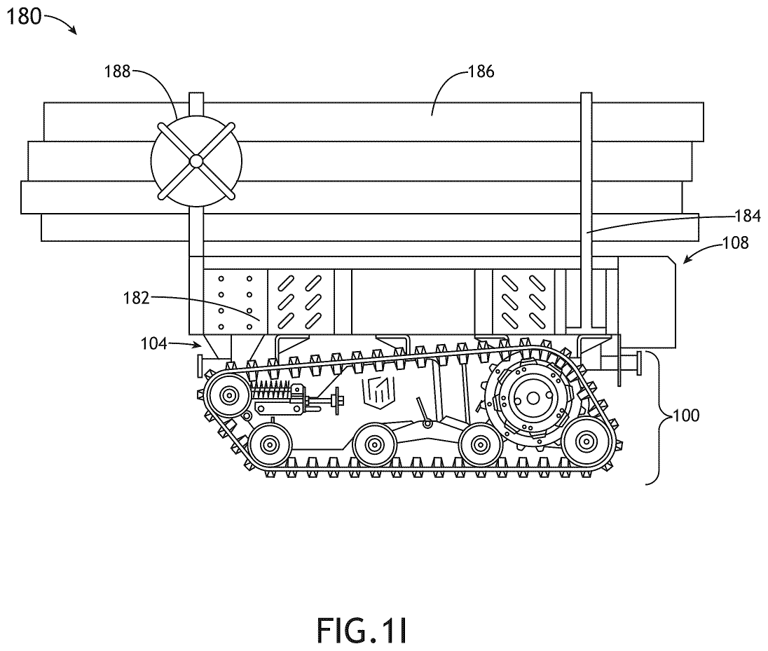

FIGS. 1A through 5 illustrate a modular continuous track system for utility vehicles, in accordance with one or more embodiments of the present disclosure. Embodiments of the present disclosure are directed to modular continuous track systems and utility vehicles that integrate the modular continuous track system. The modular continuous track system may include one or more crawler units that operate independently of each other, which allows flexibility when designing utility vehicles.

Embodiments of the present disclosure are directed to vehicles with swappable platforms and/or attachments. Embodiments of the present disclosure provide modular crawler units that can be attached to a wide range of attachments and platforms, accommodating varying widths based on the specific task at hand. Embodiments of the present disclosure also reduce the need to purchase multiple task-specific pieces of equipment, offering a cost-effective and adaptable solution for operators that require multiple tools or multifunctional tools in industries such as agriculture, landscaping, construction, and material handling. For example, a continuous track system may be swappable between a mower attachment and a dump bucket attachment. The system may also include a remote-control system, allowing an operator to operate the vehicle at a distance and perform tasks remotely and safely.

FIG. 1A illustrates a modular continuous track system 100 for utility vehicles, in accordance with one or more embodiments of the disclosure. In embodiments, the system 100 includes one or more crawler units 102a-b (e.g., a left crawler unit and a right crawler unit). The crawler units 102a-b may include a track mounting system 104 that enables the crawler units 102a-b to couple a chassis, attachment, or platform to a track frame 105. The track mounting system 104 may use any type of coupler or coupling assembly including, but not limited to, a set of brackets 106a-h.

In embodiments, the system 100 includes an electronics enclosure 108. The electronics enclosure 108 may include one or more controllers configured to control the action of the crawler units 102a-b. The electronic enclosure 108 may be attached to a utility platform, attachment, or other component of the utility vehicle. The controller within the electronic enclosure 108 may be configured to communicate with crawlers via wireline or wireless technology.

FIG. 1B illustrates a closeup side-view of a crawler unit 102, in accordance with one or more embodiments of the disclosure. In embodiments, the crawler unit 102 includes a continuous track 110 that is powered by separate drive wheels 112 and gearboxes 113. The continuous track 110 may be constructed with any type of material including, but not limited to, rubber. The crawler unit 102 may include one or more idlers 114 that guide the advancement of the continuous track 110. In embodiments, the crawler includes tension assembly 116 and/or a pivoting idler assembly 118. The components of the crawler unit 102 may be coupled to the track frame 105.

FIG. 1C and FIG. 1D illustrates the modular continuous track system 100 with the crawler units 102a-b arranged in a narrow and wide configuration, respectively, in accordance with one or embodiments of the disclosure.

When in the narrow configuration, the crawler units 102a-b may be separated by a short separation distance 122. For example, a utility vehicle that travels along a narrow pathway, such as a furrow (e.g., a trench between two crops), may be designed to include a set of crawler units 102 configured with a short separation distance 122. For example, the utility vehicle may be configured with an overall crawler width 124 (e.g., overall width of the two or more crawler units 102a-b as integrated with the utility vehicle) of less than 40 inches, less than 38 inches, less than 36 inches, less than 34 inches, less than 32 inches, less than 30 inches, less than 28 inches, less than 26 inches, less than 24 inches, less than 22 inches, or less than 20 inches. For example, the overall crawler width 124 of the utility vehicle may be approximately 26 inches or less, allowing the utility vehicle to travel along a furrow having a width of approximately 26 or greater inches.

When in the wide configuration, the crawler units may be separated by a long separation distance 126. For example, a utility vehicle that travels along a wide path, such as resurfacing equipment for roads, may be designed to include a set of crawler units 102 having a wide separation distance 126. For example, a utility vehicle may be configured with an overall crawler width 124 of more than two feet, more than three feet, more than four feet, more than five feet, or ten or more feet.

FIG. 1E illustrates a simplified schematic view of a control system 130 for the system 100, in accordance with one or more embodiments of the disclosure. In embodiments, the control system 130 includes a main controller 132. The main controller 132 provides control over one or more functions of the system 100. In embodiments, the control system 130 includes a first motor controller 134 communicatively coupled to the main controller 132 and a first motor 136. In embodiments, the control system 130 includes a second motor controller 138 communicatively coupled to the main controller 132 and a second motor 140. The first motor 136 and second motor 140 may be mechanically coupled to a respective drive wheel 112 and/or gearbox 113 of a respective crawler unit. For example, the first motor 136 and the second motor 140 may be coupled to a planetary drive (e.g., a two-stage planetary drive) that drives the drive wheel 112. The main controller 132 and/or the first motor controller 134 may be communicatively coupled to the first motor 136 by wireless or wireline means. Likewise, the main controller 132 and/or the second motor controller 138 may be communicatively coupled to the second motor 140 via wireless or wireline means.

While the main controller 132, the first motor controller 134, and the second motor controller 138 are illustrated in FIG. 1E as separate components, in an alternative embodiment, the main controller 132, the first motor controller 134, and the second motor controller 138 may be combined into a single component. Therefore, the above description should not be interpreted as a limitation on the embodiments of the present disclosure but merely as an illustration.

In embodiments, the main controller 132, the first motor controller 134 and the second motor controller 138 are included within the electronics enclosure 108. The electronic enclosure 108 may also include other electronic componentry including, but not limited to, a battery and a receiver/transceiver.

In embodiments, the control system 130 includes a wireless remote controller 142. The wireless remote controller 142 is configured to communicate with the main controller 132. For example, the wireless remote controller 142 may be configured to receive a manual input from an operator to activate the first motor 136, causing the system 100 to change direction. In another example, the wireless remote controller 142 may be configured to receive data from the control system 130 including, but not limited to, a battery-power assessment. The wireless remote controller 142 may include or be integrated with any type of form factor including, but not limited to, a smartphone, a tablet, and a laptop computer. The wireless remote controller 142 may also include other user interface components including, but not limited to, joysticks and buttons. The wireless remote controller 142 may communicate with the main controller 132 via any available wireless technology including, but not limited to, Bluetooth, Bluetooth Low Energy (BLE) Zigbee, Sigfox, narrowband IoT (NB-Iot), long-term evolution (LTE), LTE-M, Thread, Wi-Fi, Wi-SUN, Dash7, and cellular technologies (e.g., 2G, 3G, 4G, or 5G). In an alternative embodiment, the remote device is a personal device (e.g., a personal cell phone) that is configured to upload an application that allows the personal device to communicate with and control the system 100.

In embodiments, the control system 130 includes an attachment control system 144 communicatively coupled to the main controller 132. The attachment control system 144 may be changeable depending upon the platform, attachment, or implement that is coupled to the system 100. For example, the attachment control system 144 may include, but not be limited to, electronic componentry for controlling a mower attachment or platform, a dump bucket attachment or platform, a loader attachment or platform, and a hauling/stowage attachment or platform.

In embodiments, the control system 130 is configured to operate via a control profile stored in a memory within the main controller 132 or attachment control system 144. The control profile provides a set of operational parameters (e.g., maximum speed or turning angles) that the system 100 is intended to operate under for a specific utility platform. The control profiles are configurable and may automatically adjust control parameters of the drive system and/or attachment control outputs. The control profiles may be tailored to optimize the vehicle's performance based on the specific attachment and task at hand. For instance, the system 100 may operate under a mower-specific control profile when attached to a mower platform. When the system is switched to operate a loader platform, the control profile may also be quickly switched over to a loader-specific control platform (e.g., via the wireless remote controller 142).

In embodiments, each crawler unit 102 is operated independently of each other. For example, because each crawler unit 102 may include its own electric motor 136, 140 and can be attached to a platform via its own track mounting system 104, each crawler unit 102 is then operated independently from each other, and the relative movement of the crawler units 102 are coordinated by the control system 130. By operating independently, the system 100 offers great flexibility for the design and manufacturing of platforms and attachments that utilize the system 100.

FIGS. 1F to 11 illustrate side views of the system 100 incorporated into different platforms and attachments, in accordance with one or more embodiments of the disclosure. The ability of the system 100 to be incorporated into different platforms and attachments gives particular flexibility for using the system 100. For example, the system 100 may be swappable, allowing the crawler units 102a-b and the electronics enclosure 108 to be switched with different attachments or implements, saving the operator from the need to purchase multiple systems with customed track drives that are not swappable.

FIG. 1F illustrates a side view of a utility vehicle 150 that includes a mower platform 152, in accordance with one or more embodiments of the disclosure. The mower platform 152 is coupled to the crawler units 102 via the track mounting system 104. The mower platform may include a mower attachment 154 and a mower attachment coupler 156 that couples the mower attachment 154 to the mower platform 152. The mower attachment coupler 156 may include actuators for raising/lowering and/or tilting the mower attachment 154. The mower attachment may be powered by any number of mechanisms. For example, the mower attachment 154 may include an electric motor that is powered by a battery disposed on the mower attachment, the mower platform 152, and/or the system 100. In another example, the mower attachment may be powered through hydraulic, or gas-powered motor means.

FIG. 1G illustrates a side view of a utility vehicle 160 that includes a dump bucket platform 162, in accordance with one or more embodiments of the disclosure. The dump bucket platform 162 may include a dump bucket 164. The dump bucket platform 162 may also include means (hydraulic or electric actuators) for causing the dump bucket 164 to dump its contents.

In embodiments, the dump bucket platform 162 includes a step-on attachment 166 that allows an operator to step on and/or ride the utility vehicle 160 when in operation. The dump bucket platform 162 may also include one or more stability bars 168 that can be grabbed by the operator when the dump bucket platform 162 is in motion. The stability bars 168 may also include a frame or bracket for stabilizing or storing the wireless remote controller 142. The step-on attachment 166 and stability bar 168 may be included on other platforms that have integrated the system 100. Therefore, the above description should not be interpreted as a limitation on the embodiments of the present disclosure but merely as an illustration.

FIG. 1H illustrates a side view of a utility vehicle 170 that includes a loader platform 172, in accordance with one or more embodiments of the disclosure. The loader platform 172 may include a loader bucket 174 or other loading device (e.g., a grapple fork) that may be lifted and/or tilted by one or more lifting means, such as via hydraulic or electric actuators.

FIG. 1I illustrates a side view of a utility vehicle 180 that includes a hauling platform 182, in accordance with one or more embodiments of the disclosure. The hauling platform 182 may include a variety of attachments for hauling. For example, the hauling platform may include a frame 184 designed for stowing and hauling fencing supplies such as fenceposts 186 and wire spools 188. Many other configurations of the hauling platform are possible.

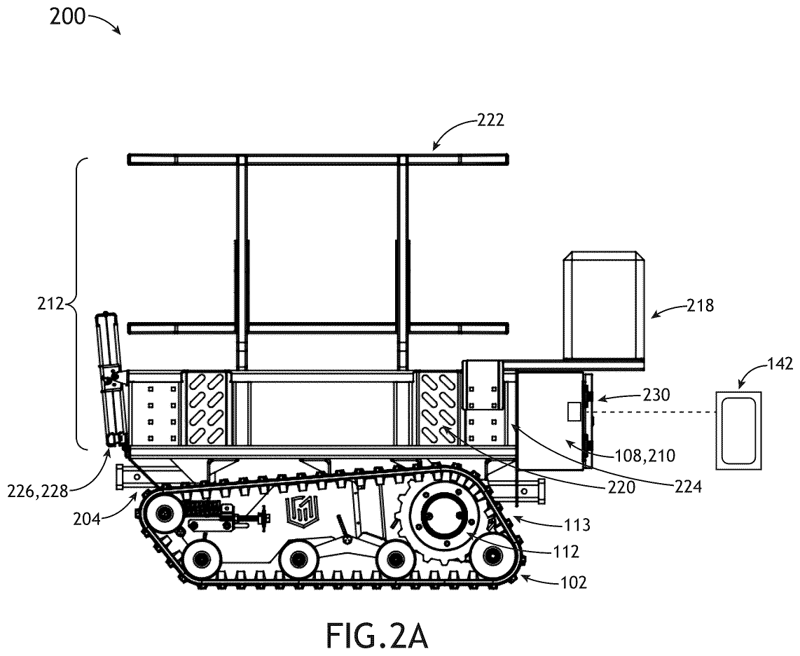

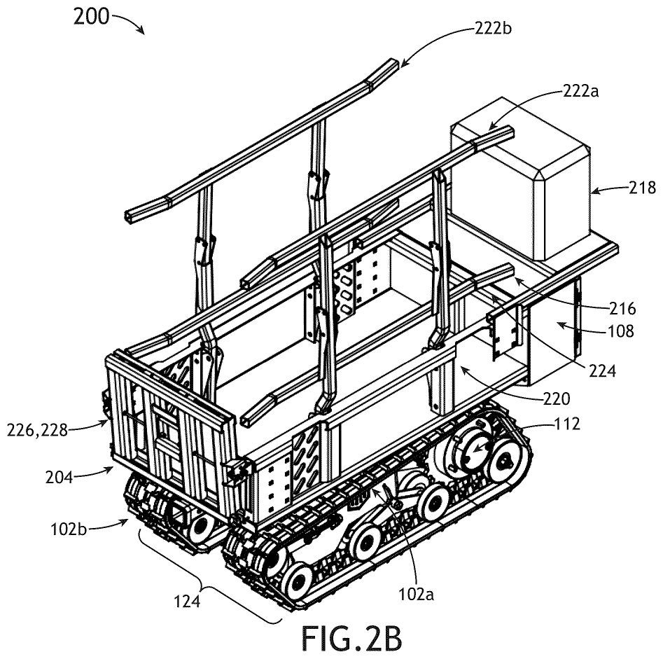

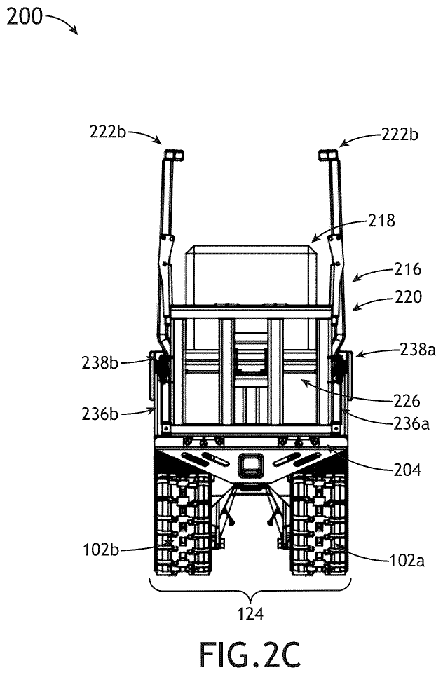

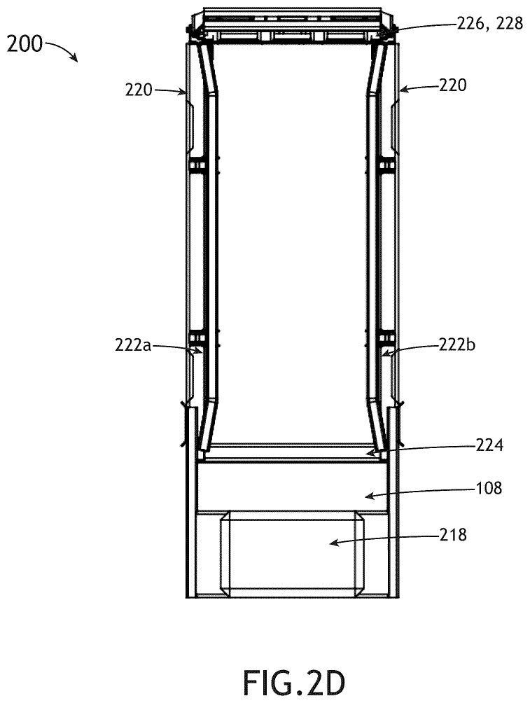

FIGS. 2A and 2B illustrate a side-view and perspective view, respectively, of a utility vehicle 200, in accordance with one or more embodiments of the present disclosure. The utility vehicle 200 includes the system 100 coupled to a hauling or cart platform. The utility vehicle 200 is configured for hauling equipment and materials. For example, the utility vehicle 200 may be configured to haul irrigation equipment (e.g., wheels and motors) down a furrow to a repair site. As detailed above, the utility vehicle may have a variety of configurations. Therefore, the above description should not be interpreted as a limitation on the embodiments of the present disclosure but merely as an illustration.

In embodiments, the utility vehicle 200 includes two crawler units 102a-b mechanically coupled to a chassis 204 (e.g., via the track mounting system 104). In an alternative embodiment, the utility vehicle 200 includes more than two crawler units. For example, the utility vehicle 200 may include four crawler units (e.g., with associated motors and motor controllers).

In embodiments, the utility vehicle 200 includes one or more batteries 210 configured to power the one or more electric motors 136, 140 and/or powered accessories of the utility vehicle 200. The batteries 210 may be included within the electronics enclosure 108. The batteries 210 may include any type of battery including but not limited to lithium-ion batteries, nickel-metal hydride batteries, and flow batteries.

In embodiments, the utility vehicle 200 includes a stowage section 212 configured to stow materials and equipment for transport. The stowage section 212 may be designed for stowing application-specific equipment, such as irrigation equipment and tools for irrigation system repair. For example, the stowage section 312 may be designed to stow a pivot wheel or tire for a pivot irrigation system. In another example, the stowage section 212 may be designed to store a jack. In another example, the stowage section 212 may include or be designed to store a toolbox 218 (e.g., via toolbox mounts).

The stowage section 212 may include one or more structural elements including, but not limited to, side rails 220, side supports 222a-b (e.g., for supporting the pivot wheel or other stowed equipment or material), one or more jack mounts, back rail 224, and one or more gates 226. The side supports 222 may be height adjustable. One or more of the one or more gates 226 may unfold into a ramp 228, such as a ramp 228 configured to guide the pivot wheel from the stowage section 212 to a ground surface.

In embodiments, the utility vehicle 200 is configured to stow greater than 200 kg, greater than 300 kg, greater than 400 kg, greater than 500 kg, greater than 600 kg, or greater than 1000 kg. For example, the utility vehicle 300 may be configured to stow 272 kg, or 600 pounds.

In embodiments, the utility vehicle 200 includes one or more receivers 230 configured to receive an input, such as an instruction from a wireless remote controller 142. For example, the receiver 230 may receive an instruction from the wireless remote controller 142 to travel forward down a furrow. The utility vehicle 200 may also include one or more transmitters to transmit data back to the wireless remote controller 142. The one or more receivers 230 and/or transmitters may communicate with the wireless remote controller 142 via wireless technologies as described above.

FIGS. 2C and 2D illustrate a front view and top view of the utility vehicle 200, respectively, in accordance with one or more embodiments of the disclosure. In embodiments, the utility vehicle includes one or more sets of lights 236a-b. The sets of lights 236a-b may be disposed on any part of the utility vehicle 200 and supply light in any direction. The sets of lights 236a-b may be configured for using any type of light source or bulb including, but not limited to, halogen lights, light emitting diode (LED) lights, fluorescent lights, and incandescent lights.

In embodiments, the utility vehicle 200 may include one or more sensors 238a-b. For example, the sensors 238a-b may include sensing devices for determining the speed and/or position of the utility vehicle 200, sensing devices for sending objects in the path of the utility vehicle 200, as well as sensing devices for performing specific functions by the utility vehicle 200. The one or more sensors 238a-b, may include, but not be limited to, inertial sensors (e.g., accelerometers, gyroscopes), ultrasonic sensors, lidar, infrared sensors, vision sensors (e.g., cameras), wheel encoders, magnetic sensors, touch sensors, load cells, proximity sensors, temperature sensors, humidity sensors, sound sensors, and GPS-based sensors. For example, the utility vehicle 200 may include cameras having the capacity for, but not limited to, one or more of day vision, night vision, tilt, and zoom. In another example, the sensors 238a-b may be configured for long-range data transmission. For instance, the one or more cameras may be configured for long-range high-definition image transmission. In another example, sensors 238a-b may include sensing devices for under-canopy data collection (e.g., via laser scanning), and soil sampling.

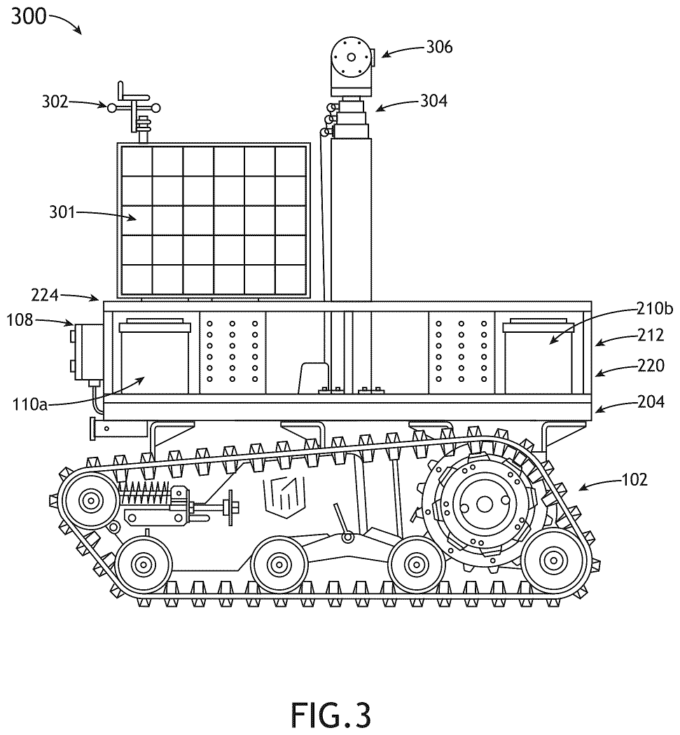

FIG. 3 illustrates a side-view of a utility vehicle 300, in accordance with one or more embodiments of the disclosure. The utility vehicle 300 may include one or more components of utility vehicles described herein, and vice versa. In embodiments, the utility vehicle includes 300 one or more solar panels 301 configured to power one or more components of the utility vehicle 300 and/or charge the batteries 210a-b.

In embodiments, the utility vehicle 300 includes a weather station 302 that may include, but is not limited to, a thermometer, hygrometer, anemometer, barometer, rain gauge, UV sensor, solar radiation sensor, data logger, and a wireless or wireline data transmitter. The weather station 302 may be used by an operator, such as a farmer or agronomist, for determining environmental conditions in the field.

In embodiments, the utility vehicle 300 includes an arm 304 configured for improving the visibility of the utility vehicle 300 (e.g., within a field or livestock pen), such as to an operator or other device. The arm 304 may be configured as a telescopic arm that can extend upward. The arm 304 may be extendable to a height greater than six feet, greater than eight feet, greater than 10 feet, greater than 12 feet, greater than 14 feet, greater than 16 feet, greater than 18 feet, or greater than 20 feet from the ground. For example, the arm 304 may be configured to be extendable by eight to ten feet. The arm 304 may be configured to be extended manually (e.g., by hand) or via a powered sub-system (e.g., controlled by the utility vehicle 300 or at the wireless remote controller 142). In embodiments, the arm 304 includes one or more cameras 306 or other types of sensors. For example, the arm 304 may include a camera 306 having pan, tilt, and/or zoom functions.

While the utility vehicles are shown with various attachments for performing various functions, the utility vehicle may be designed with, or may be converted to include, attachments or attachment sets that enable the utility vehicle to be utilized for different uses that are not illustrated herein. These attachments may be configured as either permanently coupled attachments or easily coupled and decoupled attachments. For example, an attachment set may include a pivot irrigation repair toolset as shown in FIGS. 2A to 2D. Other attachment sets may include, but not be limited to, a sprayer toolset (e.g., including a sprayer communicatively couplable to the main controller 132 via the attachment control system 144), and material tendering attachment sets, such as a seed tendering attachment set.

In an embodiment, the attachment set may include a livestock monitoring platform. For example, the utility vehicle may be built with, or modified to include, cameras for identifying livestock and livestock conditions, along with control monitoring software (e.g. via subscription) for identifying and tracking the livestock and livestock conditions. For instance, the utility vehicle, the utility vehicle hardware (e.g., attachments), and the software may be designed for monitoring a calving operation. For example, the utility vehicle may include cameras 306 with zoom capability (e.g., 20x zoom) for detecting livestock from a distance. The utility vehicle may also include solar panels 301 for keeping the one or more batteries 110a-b charged for extended periods of time. The utility vehicle may also include software than can identify livestock from images or other sensor data and provide a health assessment of the animal. For example, the software may use sensor data to determine if the animal is walking or eating.

While several utility platforms, attachments, chassis and implements are illustrated in FIGS. 1A-4 as being couplable to the system 100, many other platforms, attachments, and implements are also couplable to the system 100 including, but not limited to, skid steers, snow removal systems, snow blowers, trenchers, sweepers, sprayers (e.g., boom sprayers), and off-road trailers. Therefore, the above description should not be interpreted as a limitation on the embodiments of the present disclosure but merely as an illustration.

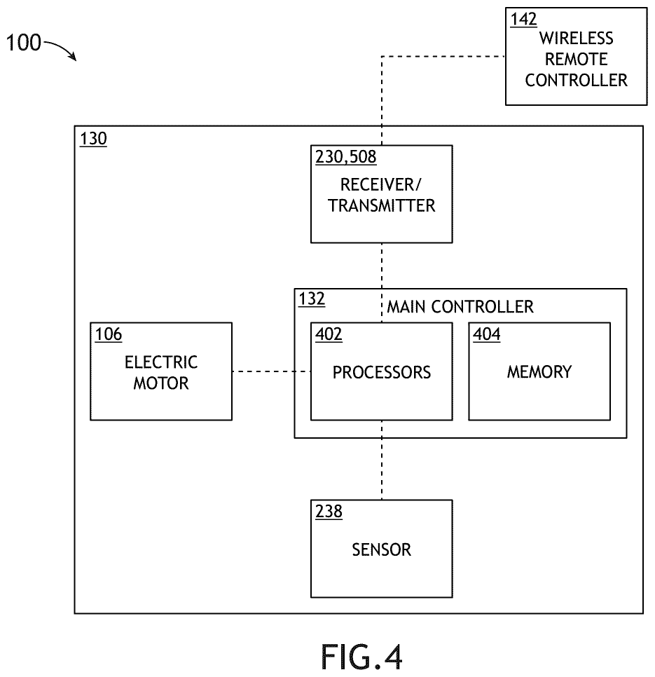

FIG. 4 illustrates a conceptual view of the system 100 that includes the control system 130 in accordance with one or more embodiments of the disclosure. The system 100 may be incorporated within the one or more utility vehicles as described herein.

In embodiments, the main controller 132 includes one or more processors 402 and memory 404. The memory 404 may maintain program instructions configured to cause the one or more processors 402 to carry out the one or more process steps described throughout the present disclosure. For example, the one or more processors 402 may be configured to receive a wireless input from receivers 230 from the wireless remote controller 142. The one or more processors 402 may then cause the one or more electric motors 136, 140 to actuate based on the wireless input. In another example, the one or more sensors 238 may send image data of a pathway ahead of the utility vehicle that includes a large hole. The one or more processors 402 may receive the image data, recognize the hole, and recognize that the hole is impassible. The one or more processors 402 may then cause the one or more electric motors 136, 140 to stop or change the speed or direction of the utility vehicle or system 100 to avoid the hole. In another example, the one or more sensors 238 may detect a wind speed (e.g., via an anemometer) that is received by the one or more processors 402. The one or more processors 402 may then cause one or more transmitters 408 to send the wind speed data to the wireless remote controller 142. In another example, the one or more processors 402 may be configured to receive from memory 404 a control profile for a specific utility platform or attachment that includes a set of operational parameters.

The one or more processors 402 of the controller 132 may include any one or more processing elements known in the art. In this sense, the one or more processors 402 may include any microprocessor-type device configured to execute software algorithms and/or instructions. In embodiments, the one or more processors 402 may include a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 404. Moreover, different subsystems of the system 100 may include a processor or logic elements suitable for carrying out a portion of the steps described throughout the present disclosure.

The memory medium 404 may include any memory medium known in the art suitable for storing program instructions executable by the associated one or more processors 402. For example, the memory medium 404 may include, but is not limited to, a read-only memory, a random-access memory, a magnetic or optical memory device (e.g., disk), a magnetic tape, and a solid-state drive. In embodiments, the memory medium 404 is configured to store one or more results from the one or more sensors 238 and/or the output of the various data processing steps described herein. It is further noted that memory medium 404 may be housed in a common controller housing with the one or more processors 402. In an alternative embodiment, the memory medium 404 may be located remotely with respect to the physical location of the processors and main controller 132. For instance, the one or more processors 402 of the main controller 132 may access a remote memory (e.g., server), accessible through a network (e.g., internet or intranet). The first motor controller 134 and the second motor controller 138 may also include processors 402 and memory 404.

In embodiments, the system 100 operates semi-autonomously. For example, an operator may manually guide the system 100 to a front end of a furrow of a field (e.g., via the wireless remote controller 142), then instruct the system 100 to travel along the furrow autonomously until the system 100 reaches an instructed destination (e.g., a pivot irrigation tower that needs repairing). For instance, one or more sensors 238 may detect a pivot wheel 214 to be repaired and stop at that location. In an alternative embodiment, the operator is required at all times to guide the system 100 and associated utility vehicle to the destination (e.g., via the wireless remote controller 142 with no autonomation). In another alternative embodiment, the system 100 is fully autonomous. For example, the system 100 may be configured to autonomously monitor livestock pens relying on sensors and algorithms for detecting and analyzing animal movement. For instance, the one or more processors may use a machine-learning model that infers a pathway for the utility vehicle based on data from the one or more sensors 238.

The modular continuous track system 100, is less restricted by design requirements for integration with various utility platforms than other track systems. For example, other track systems utilize fixed drivetrain designs that restrict how the track system can be implemented with a utility platform. Because the drivetrain for each crawler unit 102 of the system 100 includes its own motor 136, 140 and gearbox 113 (e.g., the crawlers are self-contained and do not require a separate housing for the motor/gearbox outside of the track), there is greater flexibility for the system 100 to be integrated with the utility platforms.

In embodiments, the system 100, and utility vehicles that include the system 100 are deployed in material handling and logistics work areas. For example, the system 100 may be used to move equipment, supplies, or materials in warehouses, factories, or remote locations. The control system 130 may allow operators to integrate additional features, such as accessory battery packs for extended operational time, or extra control inputs for handling more complex tasks, such as multi-function robotic arms or conveyor attachments. By enabling remote operation, operators can safely transport materials in environments where space is limited or where manual handling might be dangerous, such as in mining or chemical processing plants.

In embodiments, the system 100, and utility vehicles that include the system 100 are deployed in landscaping and construction. For example, the system 100 may be used with different swappable platforms and attachments for moving soil, gravel, or tools across a worksite. Attachments like front-end loaders, plows, or graders can be added to handle more specific functions, all controlled remotely to give the operator greater freedom of movement around the site.

When used in an agricultural setting, the system 100 may be adjusted based on the furrow dimensions and/or crop or canopy height. By adjusting the track width and attachment frame, the utility vehicle may move efficiently through rows of crops with minimal damage, making it particularly valuable during the growing season when crop height poses a challenge for traditional vehicles.

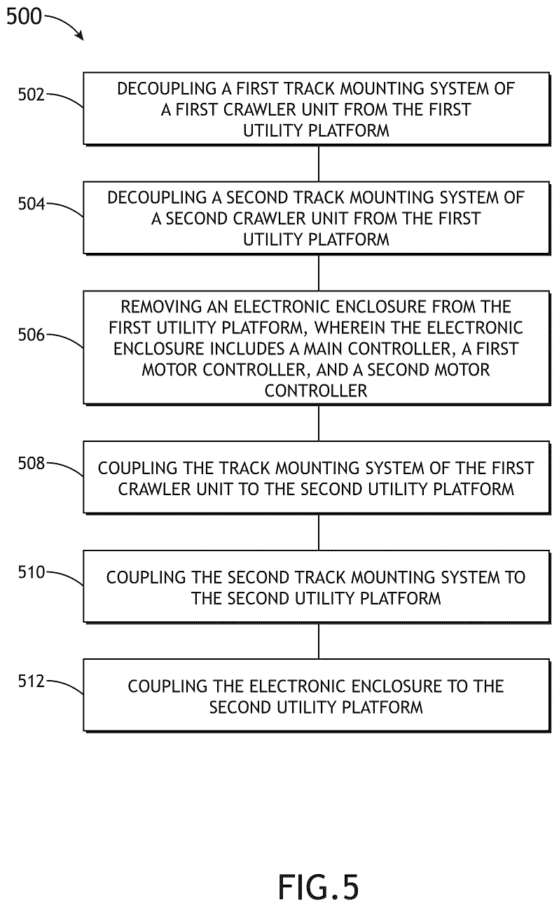

FIG. 5 illustrates a process flow diagram depicting a method 500 for exchanging a first utility platform with a second utility platform on a modular continuous track system in accordance with one or more embodiments of the disclosure. The method 500 may be used via the system 100 and/or utility vehicles as described herein. For example, the method 500 may be used to exchanging a mower platform 152 (e.g., the first utility platform) with a loader platform 172 (e.g., the second utility platform) on the system 100.

In embodiments, the method 500 includes a step 502 of decoupling a first track mounting system 104 of a first crawler unit 102a from the first utility platform. In embodiments, the method 500 includes a step 504 of decoupling a second track mounting system 104 of a second crawler unit 102b from the first utility platform. In embodiments, the method includes a step 506 of removing an electronic enclosure 108 from the first utility platform, wherein the electronic enclosure 108 includes the main controller 132, the first motor controller 134, and the second motor controller 138.

In embodiments, the method 500 includes a step 508 of coupling the track mounting system 104 of the first crawler unit 102a to the second utility platform. In embodiments, the method 500 includes a step 510 of coupling the track mounting system 104 of the second crawler unit 102b to the second utility platform. In embodiments, the methods includes a step 512 of coupling the electronic enclosure 108 to the second utility platform.

All of the methods described herein may include storing results of one or more steps of the method embodiments in a memory medium. The results may include any of the results described herein and may be stored in any manner known in the art. The memory medium may include any memory medium described herein, or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

It is further contemplated that each of the embodiments of the method described above may include any other step(s) of any other method(s) described herein. In addition, each of the embodiments of the method described above may be performed by any of the systems described herein.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. A modular continuous track system comprising:
a first crawler unit comprising a first electric motor and a first track mounting system configured to couple the first crawler unit to a first utility platform;
a second crawler unit comprising a second electric motor and a second track mounting system configured to couple the second crawler unit to the first utility platform;
and a control system configured to control operation of the first crawler unit and the second crawler unit, the control system comprising:
a main controller;
a first motor controller electrically coupled to the main controller and the first electric motor;
a second motor controller electrically coupled to the main controller and the second electric motor.

2. The modular continuous track system of claim 1, further comprising an electronic enclosure coupled to the first utility platform and configured to store the main controller, the first motor controller, and the second motor controller.

3. The modular continuous track system of claim 1, further comprising a wireless remote controller communicatively coupled to the main controller wherein the wireless remote controller is configured to control a movement of the modular continuous track system based on a remote controller input.

4. The modular continuous track system of claim 1, further comprising an attachment control system communicatively coupled to the main controller and one or more electronic components of the first utility platform.

5. The modular continuous track system of claim 1, wherein the first crawler unit and the second crawler unit are operated independently from each other, wherein movement of the first crawler unit and the second crawler unit are coordinated by the main controller.

6. The modular continuous track system of claim 1, wherein the modular continuous track system is swappable between the first utility platform and a second utility platform.

7. The modular continuous track system of claim 6, wherein the modular continuous track system is configured with different overall crawler widths when coupled to the first utility platform and the second utility platform.

8. The modular continuous track system of claim 1, wherein the modular continuous track system is configured with an overall crawler width of less than 30 inches when coupled to the first utility platform.

9. The modular continuous track system of claim 1, wherein the main controller includes one or more processors configured to execute program instructions causing the one or more processors to receive a control profile for the first utility platform, wherein the control profile comprises a set of operational parameters for the first utility.

10. The modular continuous track system of claim 1, wherein the first crawler unit comprises a set of brackets coupled to a frame of the first crawler unit and couplable to the first utility platform.

11. A utility vehicle comprising:
a utility platform; and
a modular continuous track system coupled to the utility platform, the modular continuous track system comprising:
a first crawler unit comprising a first electric motor and a first track mounting system configured to couple the first crawler unit to a first utility platform;
a second crawler unit comprising a second electric motor and a second track mounting system configured to couple the second crawler unit to the first utility platform; and
a control system configured to control operation of the first crawler unit and the second crawler unit, the control system comprising:
a main controller;
a first motor controller electrically coupled to the main controller and the first electric motor; and
a second motor controller electrically coupled to the main controller and the second electric motor.

12. The utility vehicle of claim 11, wherein the utility platform comprises a utility vehicle platform comprising a stowage section.

13. The utility vehicle of claim 12, wherein the stowage section is configured to stow a wheel of an irrigation pivot system.

14. The utility vehicle of claim 11, wherein the modular continuous track system is configured with an overall crawler width of less than 30 inches.

15. The utility vehicle of claim 11, wherein the main controller includes one or more processors configured to execute program instructions causing the one or more processors to receive a control profile for the first utility platform, wherein the control profile comprises a set of operational parameters for the first utility platform.

16. The utility vehicle of claim 11, wherein the utility platform comprises a mower platform.

17. The utility vehicle of claim 11, wherein the utility platform comprises a dump bucket platform.

18. The utility vehicle of claim 11, wherein the utility platform comprises a livestock monitoring platform.

19. The utility vehicle of claim 11, wherein the utility platform comprises a loader platform.

20. A method for exchanging a first utility platform with a second utility platform on a modular continuous track system comprising:
decoupling a first track mounting system of a first crawler unit from the first utility platform;
decoupling a second track mounting system of a second crawler unit from the first utility platform;
removing an electronic enclosure from the first utility platform, wherein the electronic enclosure includes a main controller, a first motor controller, and a second motor controller;
coupling the track mounting system of the first crawler unit to the second utility platform;
coupling the second track mounting system to the second utility platform; and
coupling the electronic enclosure to the second utility platform.
